(19) United States
(12) Patent Application Publication
(10) Pub. No.: US 2012/0302212 A1
(43) Pub. Date: Nov. 29, 2012

(54) SECURE MOBILE RADIOLOGY COMMUNICATION SYSTEM

(75) Inventors: Thomas Ross, St. Louis, MO (US); Dennis JM Donahue, St. Louis, MO (US)

(73) Assignee: Critical Medical Solutions, Inc., St. Louis, MO (US)

(21) Appl. No.: 13/479,694

(22) Filed: May 24, 2012

Related U.S. Application Data
(60) Provisional application No. 61/489,950, filed on May 25, 2011.

(51) Int. Cl. H04W 12/06

(52) U.S. Cl. 455/411

(57) ABSTRACT

A secure communication system has a server that communicates images files and corresponding text over a mobile communications network. The server has an authentication protocol for users in a circle of trust and an authorization protocol the plurality of devices uniquely identified for the users. The image files are transmitted over the mobile communications network to the authorized devices of the authenticated users in the circle of trust. The image files can be transferred by the server to the mobile devices or directly between the mobile devices.

### CROSS-REFERENCE TO RELATED APPLICATIONS

This application claims priority to U.S. Provisional Patent Application Ser. No. 61/489950 filed May 25, 2011 and titled “SECURE MOBILE RADIOLOGY COMMUNICATION SYSTEM”, which is incorporated in its entirety herein.

### STATEMENT REGARDING FEDERALLY SPONSORED RESEARCH

Not Applicable.

### APPENDIX

Not Applicable.

### BACKGROUND OF THE INVENTION

1. Field of the Invention

The present invention relates to medical imaging and HIPAA compliant mobile communications.

2. Related Art

Osirix is an open source image processing application dedicated to DICOM images (“.dcm”/“.DCM” extension) produced by medical equipment (MRI, CT, PET, PET-CT). Osirix is complementary to existing viewers, in particular to nuclear medicine viewers. It can also read many other file formats: TIFF (8, 16, 32 bits), JPEG, PDF, AVI, MPEG and Quicktime. It is fully compliant with the DICOM standard for image communication and image file formats. OsiriX is able to receive images transferred by DICOM communication protocol from any PACS or medical imaging modality (STORE SCP—Service Class Provider, STORE SCU—Service Class User, and Query/Retrieve). Another software program from Merge Healthcare works with the eFilm system. It uses a proprietary file format that follows the DICOM standard for handling, storing, printing, and transmitting information in medical imaging. One of the major tags for differentiations is that of the Modality. Merge Healthcare made eFilm Mobile available via Apple's AppStore. These existing applications follow the general guidance for telemedical services discussed in the journal paper by Claudia Reuter et al. entitled “CHOPIN: TOOLBOX FOR COMPOSITION OF TELEMEDICAL SERVICES” which was published as a part of the Proceedings of the Second IASTED International Conference of Nov. 2-4, 2009 in Cambridge, Mass. However, these existing applications only work with their respective server side clients. Accordingly, a mobile device, such as an iPhone, must be plugged into a workstation (desktop or laptop) in order to get updated images.

Accordingly, what is needed is a system such as the present invention, which allows over the air image pushes from the server, a workstation, or between smart-phones or other mobile communications using a secure data connection in a robust Circle of Trust. Other than the present invention, there is no other mobile PACS application that would allow for the 256-bit encrypted sharing of images and related medical reviews and allows for information pushes from a server or a workstation to mobile communication devices or between mobile communication devices. Accordingly, there remains a need for a mobile PACS application that allows Doctors to review a patient modality image and then securely share the image with another doctor within the circle of trust and to also share the related medical reviews, notes or comments while remaining HIPAA compliant.

Additionally, many doctors and medical professionals are searching online for DICOM viewers for their DROID and Blackberry mobile devices but none yet exist. The Critical Medical Solutions Mobile PACS Client will work with any PAC.

### BRIEF DESCRIPTION OF THE DRAWINGS

The present invention will become more fully understood from the detailed description and the accompanying drawings, wherein:

FIG. 1 is a schematic view of a prior art radiology communication system.

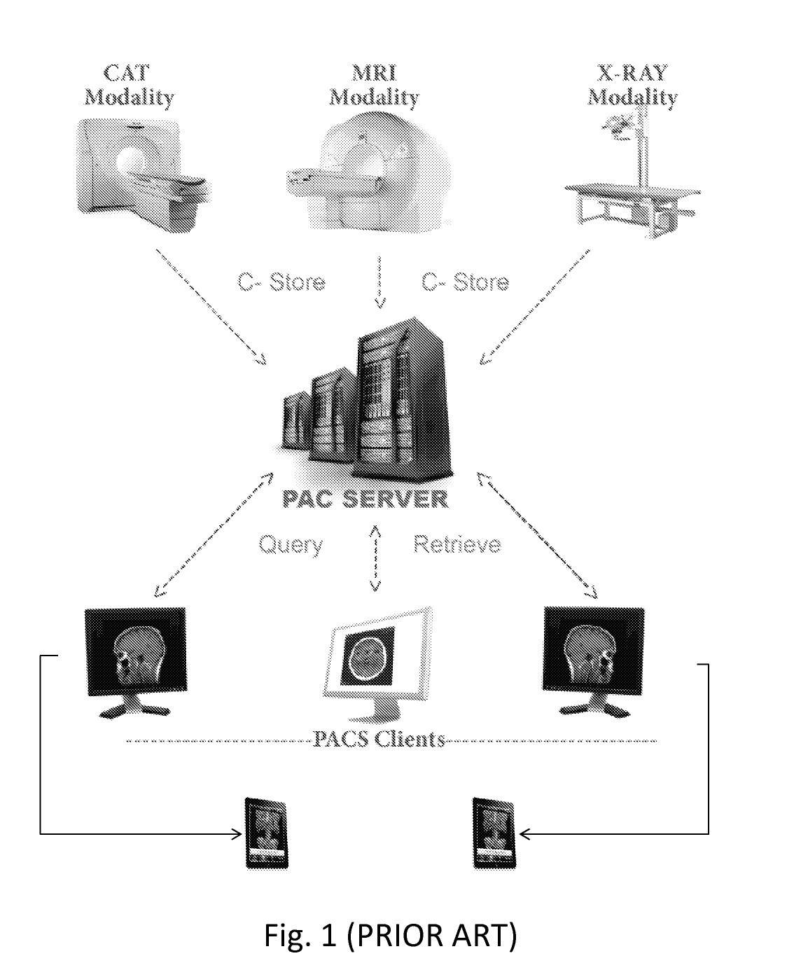

FIG. 2 is a schematic view of a secure mobile radiology communication system formed in accordance with an embodiment.

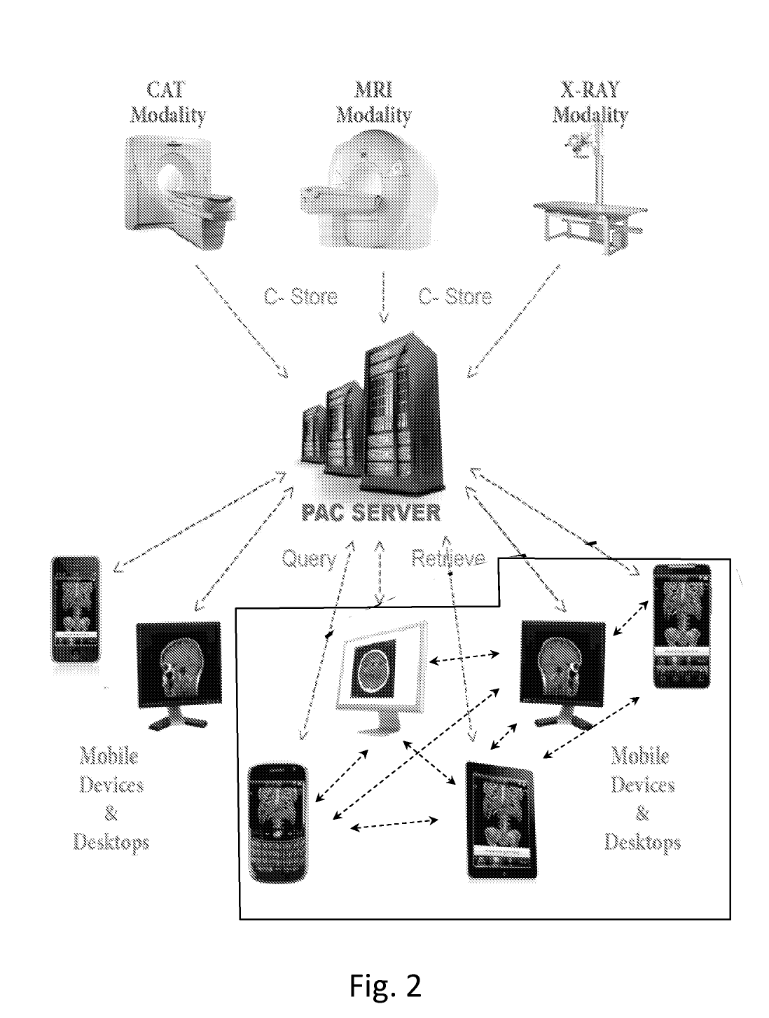

FIG. 3 is a schematic view of the secure mobile radiology communication system that illustrates the Circle of Trust.

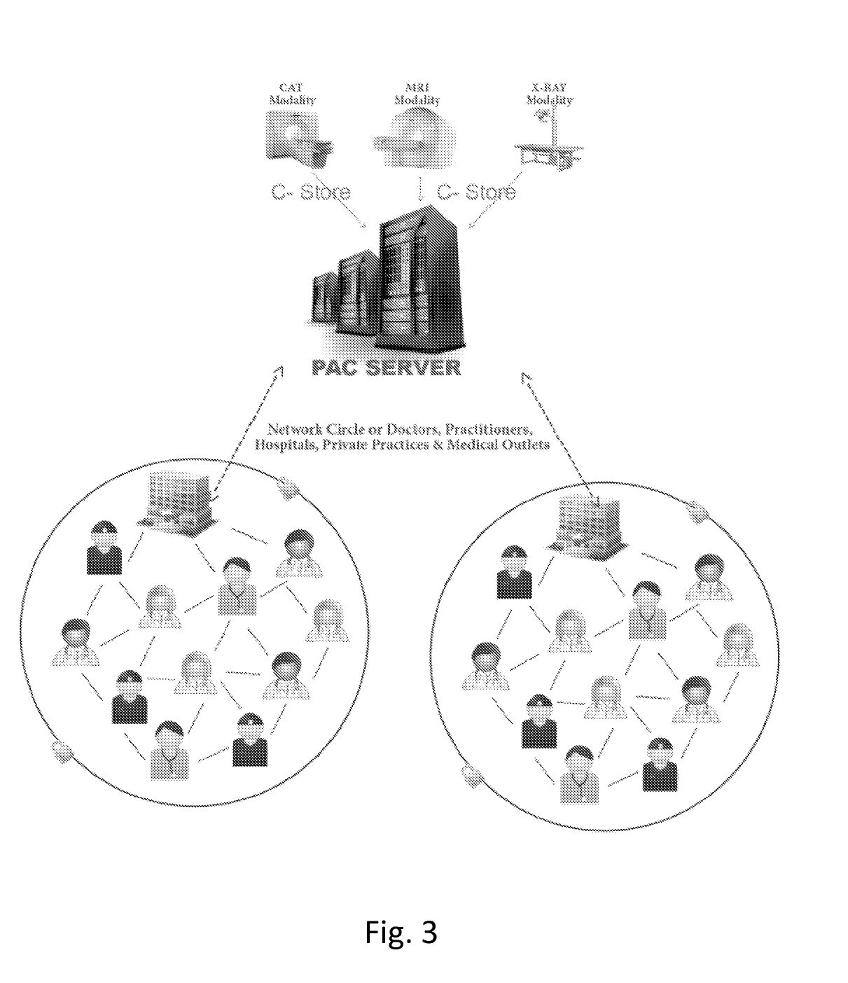

FIG. 4 is a view of mobile electronic devices utilizing the secure mobile radiology communication system.

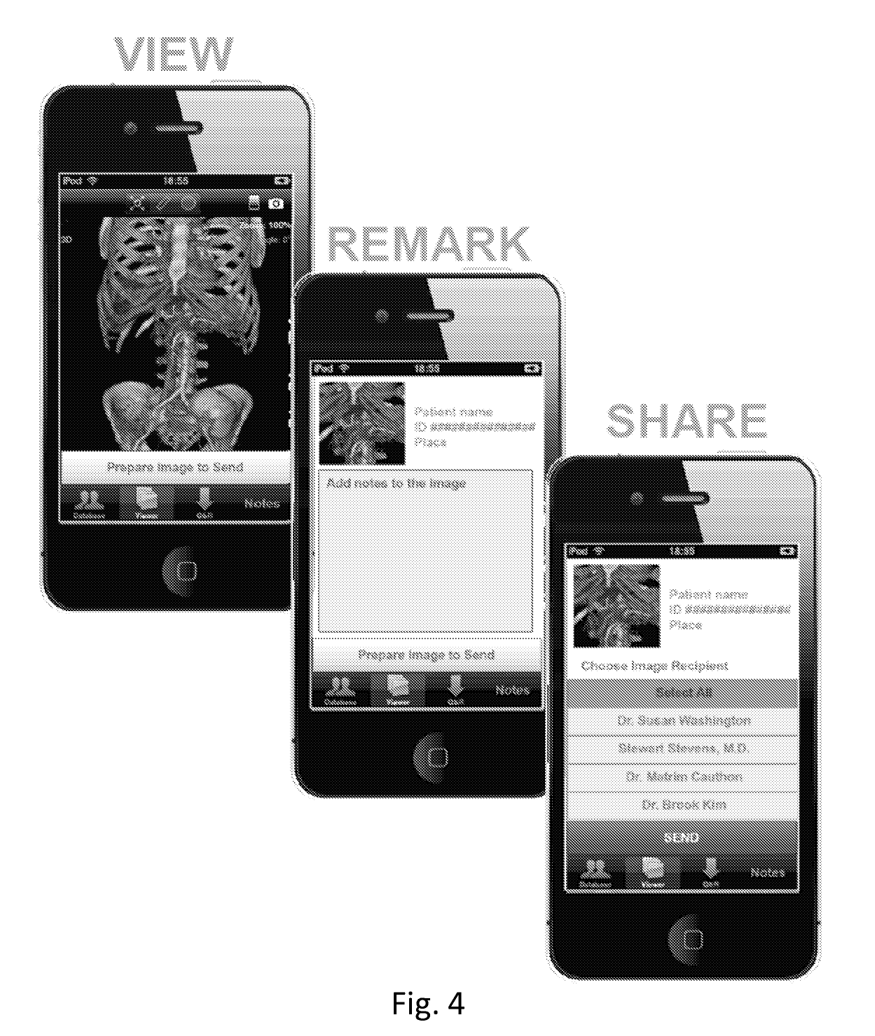

FIG. 5 is a schematic view of another embodiment of a secure mobile radiology communication system formed in accordance with an embodiment.

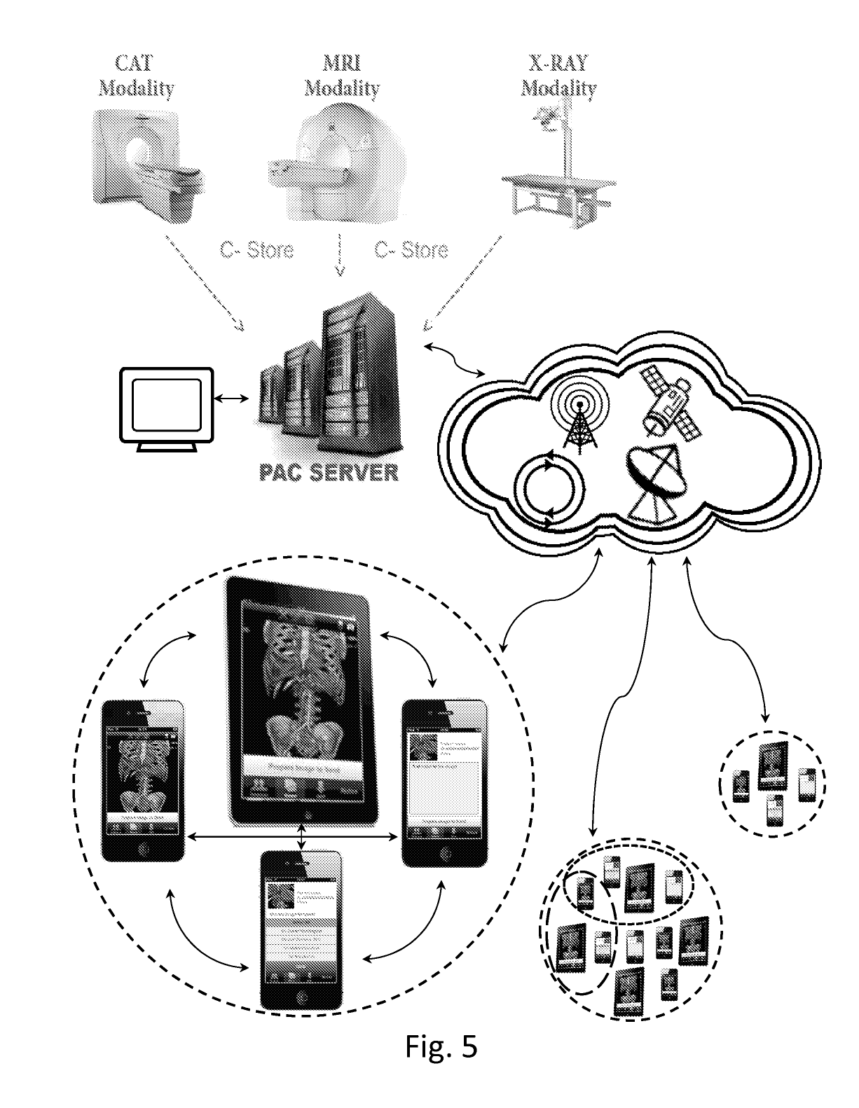

### DETAILED DESCRIPTION OF THE PREFERRED EMBODIMENTS

The following description of the preferred embodiment(s) is merely exemplary in nature and is in no way intended to limit the invention, its application, or uses.

A glossary of terms is defined in the table below.

Glossary of Terms

| | |
|---|---|
| SOW | Scope of Work |
| PACS | In medical imaging, “electronic picture archiving and communication systems |
| | (PACS) have been developed in an attempt to provide economical storage of images, |
| | rapid retrieval of images, access to images acquired with multiple modalities, and |
| | simultaneous access to multiple users at multiple sites |
| DICOM | Digital Imaging and Communications in Medicine (DICOM) is a standard for |
| | handling, storing, printing, and transmitting information in medical imaging APP |
| | Mobile Phone downloadable application |
| PHP | PHP: Hypertext Preprocessor is a widely used, general-purpose scripting language |
| | that was originally designed for web development to produce dynamic applications |
| | Q&R Query and Retrieve |
| HTTPS | Hypertext Transfer Protocol Secure (HTTPS) is a combination of the Hypertext |
| | Transfer Protocol with the SSL/TLS protocol to provide encrypted communication |
| | and secure identification of a network web server |
| TLS/SSL | Transport Layer Security (TLS) and its predecessor, Secure Socket Layer (SSL), are |
| | cryptographic protocols that provide security for communications over networks such |
| | as the Internet. TLS and SSL encrypt the segments of network connections at the |
| | Application Layer to ensure secure end-to-end transit at the Transport Layer. |
| Client | A client is an application or system that accesses a remote service on another |
| | computer system, known as a server, by way of a network |
| WADO | Web Access to DICOM Objects |

In medical imaging, electronic picture archiving and communication systems (PACS) provide economical storage of images, rapid retrieval of images, access to images acquired with multiple modalities, and simultaneous access to multiple users at multiple sites. Electronic images and reports are transmitted digitally via PACS which eliminates the need to manually file, retrieve, or transport film jackets. The universal format for PACS image storage and transfer is DICOM (Digital Imaging and Communications in Medicine). Non-image data, such as scanned documents, may be incorporated using consumer industry standard formats like PDF (Portable Document Format), once encapsulated in DICOM.

A PACS consists of four major components: (1) the imaging modalities such as CT and MRI, (2) a secured network for the transmission of patient information, (3) workstations for interpreting and reviewing images, and (4) archives for the storage and retrieval of images and reports. Combined with available and emerging networked computing (web) technology, PACS has the ability to deliver timely and efficient access to images, interpretations, and related data. PACS breaks down the physical and time barriers associated with traditional film-based image retrieval, distribution, and display.

Digital Imaging and Communications in Medicine (DICOM) is a standard for handling, storing, printing, and transmitting information in medical imaging. It includes a file format definition and a network communications protocol. The communication protocol is an application protocol that uses TCP/IP to communicate between systems. DICOM files can be exchanged between two entities that are capable of receiving image and patient data in DICOM format.

The National Electrical Manufacturers Association (NEMA) holds the copyright to the DICOM standard. DICOM enables the integration of scanners, servers, workstations, printers, and network hardware from multiple manufacturers into a picture archiving and communication system (PACS). The different devices come with DICOM conformance statements which clearly state the DICOM classes they support. DICOM has been widely adopted by hospitals and is making inroads in smaller applications like dentists' and doctors' offices.

According to the system of the present invention, the PACS Client is capable of Retrieving and Querying DICOM images via a HIPAA compliant secure HTTPS/SSL connection. The PACS Client is custom built as an application that can be downloaded for smart-phones and other mobile communication devices. Accordingly, the application can have multiple versions that can work with a variety of operating systems for such mobile devices, such as those for the iPhone, iPad, DROID and Blackberry devices.

The Mobile Medical Imaging Apps will be marketable on the respective App Stores as well as available for Critical Medical Solutions to “Bundle” for hospitals, imaging centers, doctor's offices and other medical institutions. The “Bundles” will create a secure “Mobile Circle of Trust” enabling “Authenticated Users” using “Authorized Mobile Devices” to share DICOM images as well as HIPAA compliant text based notes that will accompany the shared medical imagery. For example, with doctors #1, #2 and #3 in a particular Circle of Trust, Doctor #1 can query a patient image, view it, zoom in, measure points, and then share the medical image with Doctors #2 and #3 along with comments about the image for the other doctors to review. The preferred embodiment of the system operates most efficiently when each one of doctors has a mobile data connection.

The application requests images and patient information from the PACS server using WADO (Web Access to DICOM Objects) requests over HTTP. The images and patient information are then displayed on the screen using appropriate methods for each platform.

The applications can retrieve, query and share the DICOM images from a PAC Server including but not limited to Osirix. The applications on the mobile devices will communicate with each other as long as they are designated to be within the Circle of Trust. Text based communication is preferably transmitted over a data connection using HTTPS and SSL.

The mobile Circle of Trust creates end to end security for HIPAA compliant, secure messaging and DICOM images sent from one registered mobile device in the Circle of Trust to another mobile device or a group of other registered mobile devices in the same Circle of Trust.

The Circle of Trust is created by installing a mobile micro-client on the authorized mobile devices that will be included in a particular Circle of Trust network. The software application for the system is preferably programmed in the Java language mobile application although other software applications may also be used. It is possible for the Circle of Trust to have varying permission levels depending on the particular roles that the persons have within the Circle of Trust. For example, technicians, nurses, and doctors may each have varying permission levels based on their roles.

In one embodiment, the Mobile Medical Imaging Apps allow for a “Program Administrator”. The program administrator is logged onto the system using an administrator authorization protocol that may include a separate machine code using a unique combination of a user name and a password, and optionally a phone number. The program administrator is authorized to oversee the exchange of images over the system. For example, the program administrator may monitor the entry of users into the Circle of Trust, may track activity over the system, or may monitor activity to ensure compliance with HIPPA regulations. The program administrator has the option to edit, delete, or destroy images and/or comments sent through the system.

To install the micro-client, the user navigates to a secured site, such as a webpage with SSL protection, and inputs in multilevel security login information as well as answering security questions to confirm that the user is authenticated for the phone being authorized on the network by the network administrator. The installation, authentication and authorization procedure is similar to logging into a financial merchant account but is based on the authentication of the user for the particular authorized device. The system can be setup and managed using secure SMS, encrypted HTTPS, and other communication methodologies for the textual communication between mobile devices within the Circle of Trust. There are benefits and limitations of the various communications options. For example, secure SMS would eliminate the requirement to have or be in a data connection environment. The secure SMS platform of the present invention allows for up to 5000 characters of 256-bit encrypted data to transfer from device to device.

Once a user is authenticated, the server conducts a browser and device type detection which triggers a redirect of the mobile device web browser to a SSL secure link to begin the download to the appropriate micro-client specific application to the particular mobile device being authorized, such as a smart-phone (iPhone, Droid, Blackberry, Windows Mobile, Palm, etc.) or another portable communication device (iPad, MacBook, Windows/Linux notebook/laptop computer, etc.). In the preferred embodiment, the mobile device is a smart-phone which has a screen that shows a series of permissions that are accepted to begin an automatic download and installation of the application.

After permissions to communicate with the PACS server are granted, the micro-client sends an SSL-licensed XML string to the Circle of Trust server API that will contain the data listed in the table below.

Data String

Username
Password
Secret Question answer
MSISDN #
Mobile Device Phone Number
Date
Time
Location

This information is compared by the Circle of Trust Server (appliance) to the HARD info, i.e., securely stored medical information (encrypted data), that is pre-approved by the program administrator for that specific device through his server-based User Interface. This is the final step in device/user confirmation which brings the device into the particular circle of trust. Upon first instance of the micro-client application running on the mobile communication device, a brief tutorial is preferably provided to the user.

Once the authorized devices are in the Circle of Trust, the authenticated users (physicians, technicians and other authorized personnel) may send and/or receive DICOM images and textual content to and from the associated PACS server. The DICOM images are able to be viewed, enlarged, zoomed in upon and analyzed (although not necessarily for diagnosis). The DICOM image may also be shared amongst each other within the Particular Circle of Trust. In the preferred embodiment, each one of the users in the Circle of Trust must possess their particular authorized mobile device and must also authenticate themselves with the authorized mobile device.

It will be appreciated that as the transmission speed, bandwidth, storage and image resolution for mobile communication networks and devices continue to increase, very large files will be able to be communicated, stored and viewed within the Circle of Trust, including high resolution DICOM images. However, with current limitations in mobile communication systems, including the networks and devices, the present invention has a novel and innovative way for the users to most efficiently use the current communication infrastructure to share, store and view the images. The system administrators can store DICOM images on the PACS server at their highest resolution because the server has enough memory storage capacity to save these large electronic files. Due to the limitations in the mobile communication networks and devices, the image resolution can be reduced for the files transmitted to the mobile devices.

The image resolution may be changed dynamically as the images are being prepared for transmission to the mobile devices over the communications network. With this dynamic resolution reduction methodology, the memory module of the server does not need to maintain multiple copies of the same image at different resolutions, thereby maximizing storage space for the highest resolution images. Alternatively, the PACS server may store the DICOM images in the highest resolution format as well as one or more versions of the images with lower resolutions and send one or more of the static lower resolution versions of the image. It will also be appreciated that images can be transmitted with a hybrid resolution, with a lower resolution for most of the DICOM image and a higher resolution for a particular area of interest. When the DICOM image is selected to be shared within the Circle of Trust, the user would be able to use the system of the present invention to identify the particular portion of the image that should maintain a higher resolution. This hybrid resolution is similar to the resolution of the human eye, with the highest resolution on the focal point of the subject.

With any one of these modified resolution options (dynamic, static or hybrid), the system can use one or more modified resolution functions to change the resolution of the image being transmitted based on the speed and status of the communications network path by which the images would be transmitted to the various authorized devices. For example, the server can check the speed of the communication path to each of the mobile devices, depending on whether the network is WifFi, 3G, 4G, or some other communication protocol for one or more of the devices. The server can also query the authorized mobile devices on the status of the connection, excellent, good, or poor. Based on the speed and status of the path, the server can choose one or more resolutions for the DICOM images or may send the same resolution to all of the devices, but may repackage the files to be transmitted differently to optimize them for the particular speed and status of the paths to each of the mobile devices.

It will also be appreciated that the resolution can be selectively increased after it is received by the users. When one or more of the users first download a DICOM image that is identified for sharing, the particular image file can be in the lower resolution. As a user zooms in or otherwise enlarges the image, the local imaging module of the device can immediately process the image detailing request and zoom in or enlarge the lower resolution image that is already in the memory of the communication device. In response to this image detailing request, the communication module of the communication device can also request a higher resolution image from the server. To improve the efficiency of the overall system and the system's responsiveness from the viewpoint of the users, the higher resolution image request back to the server can identify the particular portion of the image being zoomed or enlarged, and the server could send the higher resolution for only this portion or for this portion first. In the event that the user makes a comment or any other notation on the increased resolution image, the server would automatically send the increased resolution image with such notation to all of the authenticated users in the Circle of Trust. It will also be appreciated that since the authenticated users can send images and messages to each other directly once they are in the Circle of Trust, as particularly discussed above, once one of the users receives the increased resolution image, the particular user may transmit the increased resolution image to the other users in the Circle of Trust over the mobile communication network without needing to send back any notation or other command to the server.

The transmission of the DICOM images and up to 5000 characters of text preferably uses an AES encryption engine. There are three basic classes of NIST-approved cryptographic algorithms that may be used in the present system for encrypting relatively short messages, computing digital signatures, and establishing or verifying cryptographic keying material.

The 256-bit encryption is used to manipulate the data in a way that is fundamentally difficult to undo without knowledge of a secret key; symmetric key algorithms are deployed for FDE applications. The NIST-approved algorithms for symmetric key algorithms are AES and TDES. The AES algorithm is specified in FIPS Pub 1972. AES encrypts and decrypts data in 256-bit keys.

Both the micro-client in the authorized mobile device and the Circle of Trust Server (one server with a mirrored backup device per Circle of Trust) will include AES encryption engines. The DICOM images and text up to 5000 characters are preferably encrypted by this engine and then transmitted only to the authorized/registered devices within the Circle of Trust that have received permission for accessing the data by the program administrator. Additionally, a user can only access the data after having authenticated their particular user information through the authorized devices. Initially, the transfer of the 256-bit encrypted DICOM images and data will be sent via the mobile device browser and internet data connection. (3g, 4g or WiFi). In the preferred embodiment, with the data encrypted and sent via web service, and the use of WiFi will not impose a security risk.

In another embodiment of the present invention, the system can be used in a mode in which no web data connection is required. When a web data connection is unavailable, the Micro-client will utilize the same 256-bit AES Encryption Engine to encrypt the textual data transferred from one authorized mobile device to another authorized mobile device within the particular Circle of Trust via Secure SMS up to 5000 characters. The SMS is encrypted and sent HIPAA and with real-time Protected Health Information (PHI) to the authorized mobile device within the particular Circle of Trust. The Secure SMS solution preferably uses a third party provider's communication system. Although most SMS in the world are restricted to 160 characters, the micro-client of the present invention encrypts the data and breaks it into multiple 256-bit encrypted SMS blocks which are received by the mobile application with the AES Encryption Engine where the multiple SMS blocks are decrypted with the key and reassembled for presentation as a single message within the micro-client. With this alternative embodiment, DICOM images could also be transferred at a lower resolution via Secure MMS with applicable supporting carriers in a similar manner.

In yet another embodiment of the present invention, additional security measures can be used to protect the information being communicated within the Circle of Trust. Images and data shared via secure web service or SMS/MMS may be remotely deleted, wiped or otherwise destroyed by the sending party, the receiving party or the program administrator. This sending party may also set to an automatic deletion on the Protected Health Information (PHI) after a period of time after it is opened by the receiving party. Additional security measures can include biometric protections, such as facial and/or voice recognition, for Circle of Trust authorized users to further protect the Protected Health Information from fraudulent authentications in the event that an authorized user's user name and password are compromised.

PHI data stored and even scheduled for deletion can be automatically backed up daily via available data connection through the same SSL secure licensed XML/API. PHI data scheduled for deletion will be deleted from the Circle of Trust Server at the appropriate time just as in the authorized mobile device. The backup of PHI DICOM and medical content data to the Circle of Trust Server daily in case of mobile device loss, theft or damage, and the information may be restored after authentication of a new device by the program administrator. In the event that a device is lost, stolen or destroyed, the program administrator can immediately wipe the content from the Circle of Trust Server or remotely from his authorized mobile device.

In the event that an authenticated user switches Mobile Carriers or purchases a new phone, the user can be automatically identified by his mobile phone number when prompting for the download of the micro-client into the new mobile device. The MSISDN code of the device will change requiring the authenticated user to submit a support ticket to the program administrator or answer a series of questions to verify his identity before the new MSISDN code is verified and changed in the Circle of Trust Server. Once verified, the data from the authenticated user's previous device can be installed to the new authorized mobile device so the authenticated user will not lose any critical data, images or notes. In another embodiment, the authenticated user may have multiple mobile electronic devices. Each of these devices may be verified using the data from a first device authenticated on the system.

The embodiments were chosen and described to best explain the principles of the invention and its practical application to persons who are skilled in the art. As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. For example, although the preferred embodiment teaches an authorization protocol for mobile devices based on the MSISDN code (Mobile Station International ISDN Number), it will be appreciated that other unique machine codes may be used in combination with the MSISDN or in lieu thereof, such as a MIN (Machine Identification Number). It will also be appreciated that the machine code may also be paired with a digital certificate that must reside on the particular authorized device and which can only be utilized with an authorized user's password, biometric input or other security protocol. One example of such a digital certificate is the PKI certificate (Public Key Infrastructure) that is generally used in public key cryptography. Thus, the breadth and scope of the present invention should not be limited by any of the above-described exemplary embodiments, but should be defined only in accordance with the following claims appended hereto and their equivalents.

What is claimed is:

1. A secure communication system for communicating image files over a mobile communications network, comprising:
an authentication protocol for a plurality of users in a circle of trust;
an authorization protocol for a plurality of devices uniquely identified for said users; and
a transmission of the image files over the mobile communications network to said devices of said users in said circle of trust.

2. The invention of claim 1, wherein said authorization protocol comprises a machine code and wherein said authentication protocol further comprises a unique combination of a user name and a password received from one of said devices with a confirmed authorization protocol.

3. The invention of claim 2, wherein said authorization protocol further comprises a phone number.

4. The invention of claim 1, further comprising a plurality of alpha-numeric characters associated with at least one of said image files.

5. The invention of claim 1, further comprising a server having a memory module, a security module and a communication module, wherein said memory module stores the image files in a high resolution format, wherein said security module hosts said authorization protocol and said authentication protocol, and wherein said communication module transmits the images files over the mobile communications network to authenticated users operating authorized devices in said circle of trust in at least one of said high resolution format and a lower resolution format.

6. The invention of claim 5, wherein said communication module further comprises a modified resolution function corresponding with at least one of a speed and a status of a communications path for the mobile communications network, wherein said modified resolution function is selected from the functions consisting of a dynamic resolution function, a static resolution function and a hybrid resolution function.

7. The invention of claim 6, wherein the hybrid resolution function enables a user to select a portion of a low resolution image to be viewed at high resolution.

8. The invention of claim 1, wherein said plurality of users in said circle of trust may add at least one of notes or comments to said image file and retransmit said image file over said mobile communications network.

9. The invention of claim 1, wherein said plurality of users includes a program administrator that is authorized to at least one of edit, delete, or destroy said image files to comply with HIPPA.

10. A method for securely communicating image files over a mobile communications network, comprising the steps of:
authenticating a plurality of users in a circle of trust;
authorizing a plurality of devices uniquely corresponding with said plurality of users;
downloading a micro-client application to each of said devices;
uploading a unique combination of a username, password and machine code information from each of said users operating said micro-client application on said uniquely corresponding devices;
comparing said uploaded information to stored information;
confirming said users operating said micro-client application on said uniquely corresponding devices as a plurality of members in a circle of trust;
sending and receiving the image files over the mobile communications network to said members in said circle of trust.

11. The invention of claim 10 further comprising:
storing the image files in a high resolution format; and
transmitting the images files over said mobile communications network to authenticated users operating said micro-client application in at least one of said high resolution format and a lower resolution format.

12. The invention of claim 11 further comprising modifying a resolution of said image files to corresponding with at least one of a speed and a status of a communications path for said mobile communications network, wherein said resolution is modified using at least one of a dynamic resolution function, a static resolution function and a hybrid resolution function.

13. The invention of claim 12 further comprising selecting a portion of a low resolution image to be viewed at high resolution using the hybrid resolution function.

14. The invention of claim 10 further comprising:
adding at least one of notes or comments to the image file; and
retransmitting the image file over the mobile communications network.

15. The invention of claim 10 further comprising at least one of editing, deleting, or destroying image files to comply with HIPPA.

16. A secure communication system for communicating image files over a mobile communications network, comprising:
an authentication protocol for a plurality of users in a circle of trust, wherein at least one of said plurality of users is an administrator;
an authorization protocol for a plurality of devices uniquely identified for said users;
a transmission of the image files over the mobile communications network to said devices of said users in said circle of trust; and
an administrator authorization protocol that allows the administrator to at least one of edit, delete, or destroy image files to comply with HIPPA.

17. The invention of claim 16, wherein said authorization protocol comprises a machine code and wherein said authentication protocol further comprises a unique combination of a user name and a password received from one of said devices with a confirmed authorization protocol.

18. The invention of claim 16, further comprising a server having a memory module, a security module and a communication module, wherein said memory module stores the image files in a high resolution format, wherein said security module hosts said authorization protocol and said authentication protocol, and wherein said communication module transmits the images files over the mobile communications network to authenticated users operating authorized devices in said circle of trust in at least one of said high resolution format and a lower resolution format.

19. The invention of claim 18, wherein said communication module further comprises a modified resolution function corresponding with at least one of a speed and a status of a communications path for the mobile communications network, wherein said modified resolution function is selected from the functions consisting of a dynamic resolution function, a static resolution function and a hybrid resolution function.

20. The invention of claim 19, wherein the hybrid resolution function enables a user to select a portion of a low resolution image to be viewed at high resolution.
